(19) United States
(12) Patent Application Publication
(10) Pub. No.: US 2010/0062321 A1
(43) Pub. Date: Mar. 11, 2010

(54) COOLING APPARATUS AND VEHICLE

(76) Inventor: Yoshiyuki Nakamura, Nishikamo-gun (JP)

Correspondence Address: KENYON & KENYON LLP, 1500 K STREET N.W., SUITE 700, WASHINGTON, DC, 20005, US

(21) Appl. No.: 12/443,853

(22) PCT Filed: Oct. 22, 2007
(86) PCT No.: PCT/JP2007/070551

§ 371 Date: Apr. 1, 2009

(30) Foreign Application Priority Data
Oct. 23, 2006 (JP) 2006-287624
Nov. 24, 2006 (JP) 2006-316974

(51) Int. Cl. H01M 10/50

(52) U.S. Cl. 429/62; 429/120

(57) ABSTRACT

A cooling apparatus includes a case which houses a power storage unit, a heat transfer member which can contact with the case, and a driving mechanism which relatively moves the case and the heat transfer member and operates between a first state in which the case and the heat transfer member is in contacting state and a second state in which the case and the heat transfer member is in non-contacting state.

This is a 371 national phase application of PCT/JP2007/070551 filed 22 Oct. 2007, claiming priority to Japanese Patent Applications No. 2006-287624 filed 23 Oct. 2006, and No. 2006-316974 filed 24 Nov. 2006, respectively, the contents of which are incorporated herein by reference.

### FIELD OF THE INVENTION

The present invention relates to a cooling apparatus which can prevent an increase in temperature of a power storage unit and can avoid excessive cooling of the power storage unit, and to a vehicle including the cooling apparatus.

### BACKGROUND OF THE INVENTION

Hybrid vehicles, fuel cell vehicles, and electric vehicles have conventionally been used which run by driving force from electric motors. Batteries or capacitors (condensers) are mounted on these vehicles to store electric power for supply to the electric motors. The batteries or the like have performance and useful lives which largely depend on ambient temperatures. Especially when charge and discharge are performed at a high temperature, the batteries or the like may be significantly deteriorated. It is thus necessary to cool the batteries or the like in order to prevent the deterioration thereof.

Proposals have been made in which a battery case accommodates a plurality of batteries and a heat transfer member (heat transfer plate or heat transfer sheet) is placed between the battery case and the batteries (for example, see Patent Documents 1 and 2) . In this arrangement, heat generated in the batteries can be transferred to the battery case through the heat transfer member to prevent an increase in temperature of the batteries. The battery case is fixed to a vehicle body.

[Patent Document 1] Japanese Patent Publication No. 2003-291656 (paragraph number 0014, and FIGS. 1 and 2)

[Patent Document 2] Japanese Patent Publication No. 2000-58016 (claims, paragraph numbers 0017, 0027, 0032, and FIGS. 1 and 5) .

[Patent Document 3] Japanese Patent Publication No. 2001-229663

### SUMMARY OF THE INVENTION

### Problems to be Solved by the Invention

In the abovementioned arrangements described in Patent Documents 1 and 2, however, the heat transfer member always contacts with the batteries to result in problems described below.

Specifically, the arrangement in which the heat transfer member remains contacting with the batteries can radiate heat generated in the batteries to the outside, but the batteries may be cooled excessively at some ambient temperatures.

For example, the temperature of the vehicle body may drop below zero in winter. In this case, the battery case and the heat transfer member fixed (coupled) to the vehicle body may be cooled excessively and the battery may also be cooled excessively.

The battery can achieve satisfactory battery characteristics in a predetermined range of temperatures. If the temperature of the battery is lower than the lower limit or higher than the upper limit of the temperature range, the satisfactory battery characteristics cannot be provided.

Therefore, in the arrangements in which the heat transfer member remains contacting with the batteries, the batteries may be cooled excessively to fail to provide the satisfactory battery characteristics.

It is thus an object of the present invention to provide a cooling apparatus which can prevent an increase in temperature of a power storage unit and can avoid excessive cooling of the power storage unit, and a vehicle including the cooling apparatus.

### Means for Solving Problems

A cooling apparatus according to the present invention, which is mounted on a vehicle, comprises a case which houses a power storage unit, and a driving mechanism which moves the case relative to a vehicle body and operates between a first state in which the case and the vehicle body are in a contacting state and a second state in which the case and the vehicle body are in a non-contacting state.

The driving mechanism may be configured by a gear which is provided with the case and a supporting member which meshes with the gear and supports the case via the gear. Wherein, by changing a meshing position of the gear with the supporting member, the case can be moved between the contacting state and the non-contacting state.

On the other hand, the cooling apparatus may be provided with a detection sensor which is adapted to detect a temperature of the power storage unit and control means which controls driving of the driving mechanism. Wherein the control means can drive the driving mechanism between the first state and the second state based on the temperature detected by the detection sensor. Specifically, the control means drives the driving mechanism into the first state when the temperature detected by the detection sensor is equal to or higher than a threshold and the control means drives the driving mechanism into the second state when the detected temperature is lower than the threshold.

The driving mechanism may include an expandable/contractible member which can expand and contract depending on a temperature outside the case. For example, the expandable/contractible member may be made of an elastic body and a low-boiling-point solvent housed in the elastic body or may be made of bimetal or a shape memory alloy.

A heat transfer material may be provided for at least one of surfaces of the case and the vehicle body that contact each other. The case may contain a fluid for use in cooling the power storage unit. For example, a fluorochemical inert fluid may be used as the fluid contained in the case.

The vehicle according to the present invention includes the above-mentioned cooling apparatus.

### EFFECTS OF THE INVENTION

According to the cooling apparatus of the present invention, the driving mechanism can achieve switching between the contacting state and the non-contacting state of the case and the vehicle body to prevent an increase in temperature of the case (power storage unit) and excessive cooling of the case (power storage unit).

Specifically, when the vehicle body and the case contact each other, heat of the case (in other words, heat generated in the power storage unit) can be radiated to the vehicle body (outside the case) to enable prevention of an increase in temperature of the case (power storage unit). When the vehicle body and the case do not contact each other, it is possible to prevent the vehicle body cooled due to the ambient temperature from excessively cooling the case (power storage unit).

### BRIEF DESCRIPTION OF DRAWINGS

FIG. 1A A schematic diagram showing the configuration of a cooling apparatus which is Embodiment 1 of the present invention when a heat transfer plate and a battery case contact each other.

FIG. 1B A schematic diagram showing the configuration of the cooling apparatus which is Embodiment 1 of the present invention when the heat transfer plate and the battery case do not contact each other.

FIG. 2 A diagram showing the configuration for controlling the driving of the cooing apparatus of Embodiment 1.

FIG. 3 A flow chart showing the control operation of the cooling apparatus in Embodiment 1.

FIG. 4A A schematic diagram showing the configuration of a cooling apparatus which is a modification of Embodiment 1 when a heat transfer plate and a battery case contact each other.

FIG. 4B A schematic diagram showing the configuration of the cooling apparatus which is the modification of Embodiment 1 when the heat transfer plate and the battery case do not contact each other.

FIG. 5A A schematic diagram showing the configuration of a cooling apparatus which is Embodiment 2 of the present invention when a vehicle body and a battery case contact each other.

FIG. 5B A schematic diagram showing the configuration of the cooling apparatus which is Embodiment 2 of the present invention when the vehicle body and the battery case do not contact each other.

FIG. 6 A flow chart showing the control operation of the cooling apparatus in Embodiment 2.

FIG. 7A A schematic diagram showing the configuration of a cooling apparatus which is Embodiment 3 of the present invention when a vehicle body and a battery case contact each other.

FIG. 7B A schematic diagram showing the configuration of the cooling apparatus which is Embodiment 3 of the present invention when the vehicle body and the battery case do not contact each other.

FIG. 8A A schematic diagram showing the configuration of a cooling apparatus which is a modification of Embodiment 3 when a heat transfer plate and a battery case contact each other.

FIG. 8B A schematic diagram showing the configuration of the cooling apparatus which is the modification of Embodiment 3 when the heat transfer plate and the battery case do not contact each other.

FIG. 9A A schematic diagram showing the configuration of a cooling apparatus which is Embodiment 4 of the present invention when a vehicle body and a battery case contact each other.

FIG. 9B A schematic diagram showing the configuration of the cooling apparatus which is Embodiment 4 of the present invention when the vehicle body and the battery case do not contact each other.

### DETAILED DESCRIPTION

Preferred embodiments of the present invention will hereinafter be described.

### Embodiment 1

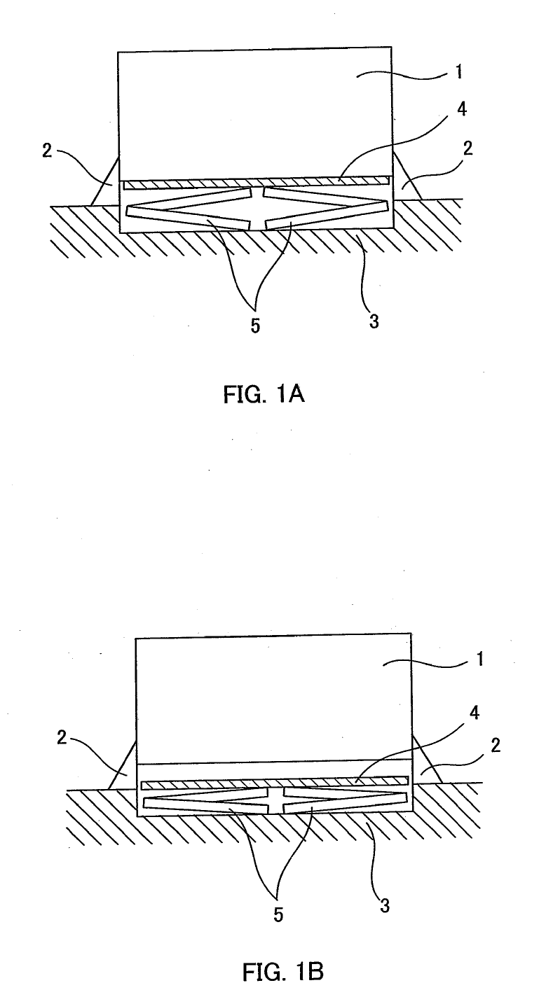

First, the arrangement of a cooling apparatus which is Embodiment 1 of the present invention will be described with reference to FIGS. 1A and 1B. The cooling apparatus of Embodiment 1 is mounted on a vehicle. The position of the cooling apparatus placed in the vehicle can be set as appropriate.

In FIGS. 1A and 1B, a battery case 1 houses a battery unit (not shown) and is fixed to a vehicle body 3 via fixing members 2. The battery unit includes a plurality of batteries (secondary batteries) connected electrically in series. Since the battery case 1 is supported on the fixing members 2 secured to the vehicle body 3, the battery case 1 is placed at a position separate from the surface of the vehicle body 3.

While the use of the secondary battery as a power storage unit is described in Embodiment 1, an electric double layer capacitor (condenser) may be used as the power storage unit instead of the secondary battery.

The battery case 1 may contain a fluid for use in cooling the battery unit in addition to the battery unit. For example, a fluorochemical inert fluid can be used as the fluid. More specifically, it is possible to use Fluorinert, Novec HFE (hydrofluoroether), and Novec1230 manufactured by 3M. The fluid for cooling contained in the battery case 1 can efficiently transfer heat generated in charge and discharge of the battery unit to the battery case 1, thereby improving heat radiation of the battery unit.

To further enhance the heat radiation of the battery unit, the cooling fluid may be circulated within the battery case 1. Specifically, a circulating path for the cooling fluid may be connected to the battery case 1 and a pump may be provided on the circulating path to circulate the cooling fluid.

Elevators 5 are placed in the space formed between the battery case 1 and the vehicle body 3. One end of each of the elevators 5 is fixed to the vehicle body 3 and the other end thereof is fixed to a heat transfer plate 4. As shown in FIGS. 1A and 1B, the elevators 5 have a structure (so-called pantograph type link mechanism) in which a plurality of links are connected via a rotation shaft such that the elevators 5 can expand and contract in a vertical direction in FIGS. 1A and 1B (direction in which the heat transfer plate 4 is movable).

As shown in FIG. 1A, the heat transfer plate 4 contacts with the bottom surface of the battery case 1 while the elevators 5 expand. As shown in FIG. 1B, the heat transfer plate 4 is separate from the bottom surface of the battery case 1 while the elevators 5 contract.

The heat transfer plate 4 can be made of a material having a high thermal conductivity. The shape of the heat transfer plate 4 can be set as appropriate. As long as the shape generally contacts with the overall bottom surface of the battery case 1, the heat transfer plate 4 can improve the heat radiation effect while it contacts with the battery case 1, as later described.

The battery unit housed in the battery case 1 generates heat in charge and discharge and the heat is transferred to the battery case 1. When the heat transfer plate 4 contacts with the battery case 1 as shown in FIG. 1A, the heat of the battery case 1 is transferred to the heat transfer plate 4 to achieve efficient heat radiation to the outside of the battery case 1.

Although part of the heat of the battery case 1 is radiated directly into the air from the battery case 1, the heat transfer plate 4 contacting with the battery case 1 enables transfer of the heat of the battery case 1 to the heat transfer plate 4 with higher efficiency than in the heat radiation into the air. As a result, the heat radiation effect of the battery case 1 can be improved, which allows prevention of an increase in temperature of the battery case 1 (battery unit).

The heat transferred to the heat transfer plate 4 is then radiated directly into the air from the heat transfer plate 4 or transferred to the vehicle body 3 via the elevators 5. Since the battery case 1 is supported on the fixing members 2, the heat of the battery case 1 is also transferred to the fixing members 2.

On the other hand, when the heat transfer plate 4 is separate from the battery case 1 as shown in FIG. 1B, the heat generated in the battery case 1 is not transferred to the heat transfer plate 4.

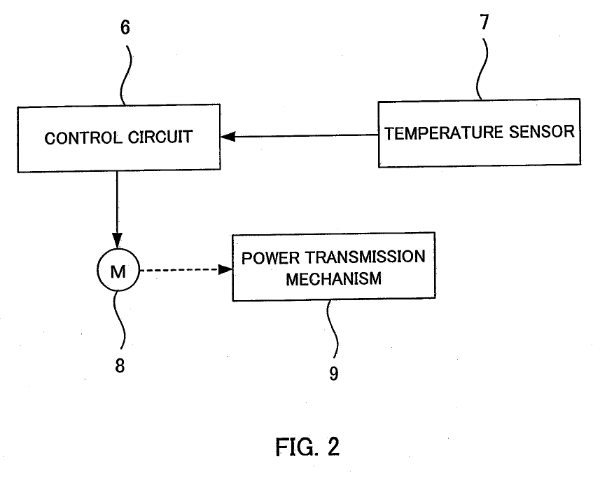

Next, description will be made of a configuration (circuit configuration and mechanical configuration) for controlling the operation of the cooling apparatus in Embodiment 1 with reference to FIG. 2. Arrows shown by solid lines represent electrical connection and arrow shown by dotted line represents mechanical connection in FIG. 2.

A temperature sensor 7 detects the temperature of the battery case 1 and outputs the detected information to a control circuit 6. In Embodiment 1, the temperature of the battery case 1 is detected to achieve indirect detection of the temperature of the battery unit placed within the battery case 1. Alternatively, the temperature of the battery unit may be detected directly.

The control circuit 6 controls the driving of a motor 8 based on the output from the temperature sensor 7. The control circuit 6 can perform not only the operation described in Embodiment 1 but also control of devices mounted on the vehicle equipped with the cooling apparatus of Embodiment 1 such that the vehicle is driven in a desired state.

The elevators 5 are coupled to the motor 8 via a power transmission mechanism 9 so that the driving force of the motor 8 is transferred to the elevators 5.

In the abovementioned configuration, the control circuit 6 can control the driving of the motor 8 to operate the elevators 5 between a state (first state) shown in FIG. 1A and a state (second state) shown in FIG. 1B.

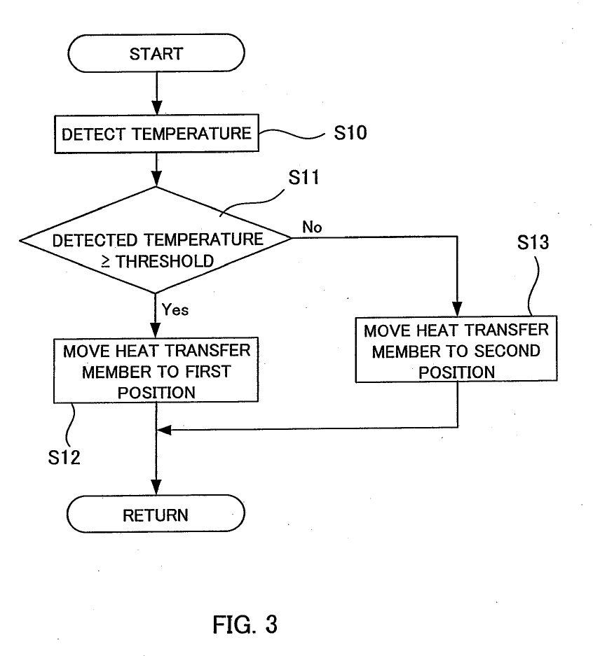

Next, the operation of the control circuit 6 will be described with reference to a flow chart shown in FIG. 3.

At step S10, the control circuit 6 detects the temperature of the battery case 1 (battery unit placed within the battery case 1) based on the output from the temperature sensor 7. At step S11, the control circuit 6 determines whether the temperature detected at step S10 is equal to or higher than a threshold. When the detected temperature is equal to or higher than the threshold, the flow proceeds to step S12. When the detected temperature is lower than the threshold, the flow proceeds to step S13.

The threshold refers to a temperature used as a criterion for preventing excessive cooling or an increase in temperature of the battery case 1 and is set previously. Specifically, when the temperature of the battery case 1 is lower than the threshold, the battery case 1 may be cooled excessively, and when the temperature of the battery case 1 is equal to or higher than the threshold, the increased temperature of the battery unit may deteriorate the performance of the battery unit. The specific value of the threshold can be set as appropriate in view of the abovementioned considerations.

At step S12, the control circuit 6 controls the driving of the motor 8 to operate the elevators 5 and move the heat transfer plate 4 to a first position where the heat transfer plate 4 contacts with the battery case 1. The heat transfer plate 4 contacting with the battery case 1 in this manner allows the heat generated within the battery case 1 to be radiated to the outside of the battery case 1 through the heat transfer plate 4. This can prevent an increase in temperature of the battery case 1 (battery unit).

At step S13, the control circuit 6 controls the driving of the motor 8 to operate the elevators 5 and move the heat transfer plate 4 to a second position where the heat transfer plate 4 is separate from the battery case 1. The second position (in other words, the distance from the bottom surface of the battery case 1) may be any position of the heat transfer plate 4 separate from the bottom surface of the battery case 1 and can be set as appropriate.

As described above, the separation of the heat transfer plate 4 from the battery case 1 can prevent the battery case 1 from being cooled more than necessary through the heat transfer plate 4.

Specifically, if the temperature of the battery unit is lower than the threshold and the heat transfer plate 4 contacts with the battery case 1, the battery case 1 may be cooled more than necessary through the heat transfer plate 4. The battery case 1 cooled excessively in this manner may lead to deterioration of the performance of the battery unit placed within the battery case 1.

To address this, in Embodiment 1, the heat transfer plate 4 is moved to the position separate from the battery case 1 as described above to prevent excessive cooling of the battery case 1 through the heat transfer plate 4. Since the battery case 1 is placed at the position separate from the surface of the vehicle body 3 by using the fixing members 2 in Embodiment 1, it is possible to prevent the vehicle body 3 cooled excessively due to the ambient temperature from excessively cooling the battery case 1.

If the vehicle body 3 is excessively cooled, the battery case 1 may be cooled through the fixing members 2. However, only part of the battery case 1 is supported on the fixing members 2, so that the contact area is smaller than in the arrangement in which the overall bottom surface of the battery case 1 contacts with the vehicle body 3. Thus, excessive cooling of the battery case 1 can be avoided.

When the fixing members 2 are made of a heat insulating material, it is possible to prevent cooling of the battery case 1 through the fixing members 2 more favorably.

While the driving of the motor 8 is controlled on the basis of the information detected by the temperature sensor 7 in Embodiment 1, the present invention is not limited thereto. For example, an operation unit such as an operation panel may be provided, and the motor 8 may be driven in response to the manipulation of the operation unit. In other words, the operation unit can be manipulated to contact the heat transfer plate 4 with the battery case 1 and to separate the heat transfer plate 4 from the battery case 1.

A heat transfer material (for example, heat transfer grease) may be applied to or a heat transfer sheet may be formed on at least one of the contacting surfaces of the battery case 1 and the heat transfer plate 4 to improve the heat conductivity. This can provide higher heat radiation of the battery case 1.

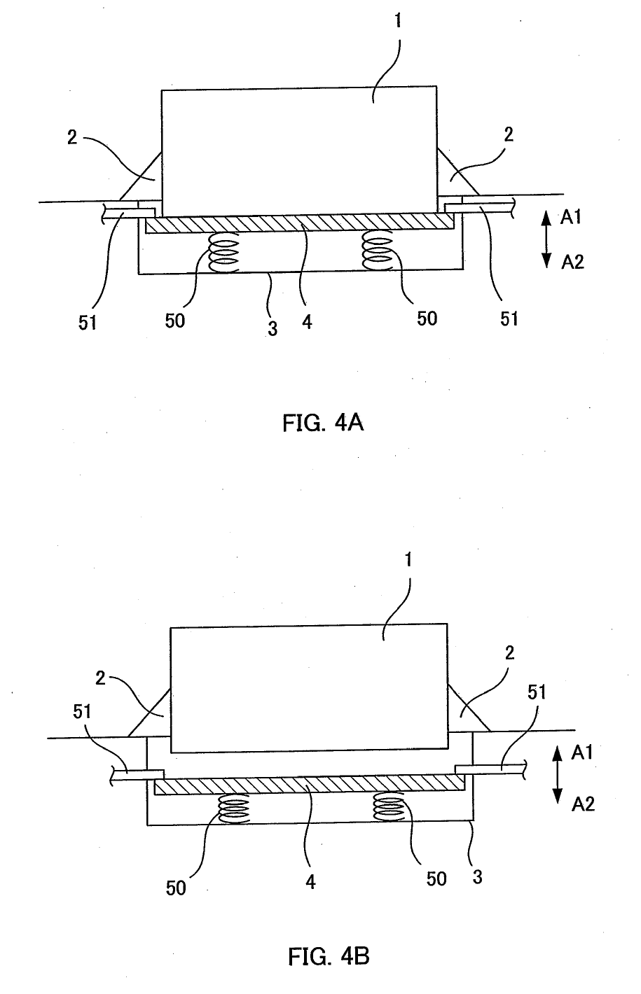

Next, a modification of Embodiment 1 will be described with reference to FIGS. 4A and 4B. In FIGS. 4A and 4B, members identical to those described in Embodiment 1 (FIGS. 1A and 1B) are designated with the same reference numerals.

In the modification, springs 50 are used instead of the elevators 5 of Embodiment 1. One end of the spring 50 is fixed to a vehicle body 3 and the other end of the spring 50 is fixed to a heat transfer plate 4. Lever members 51 which can contact with the heat transfer plate 4 are provided for the vehicle body 3.

The lever members 51 are coupled to a motor 8 via a power transmission mechanism 9 and are movable in a direction of an arrow A1 and a direction of an arrow A2 in FIGS. 4A and 4B in response to driving force from the motor 8. The vehicle body 3 has an opening portion (not shown) for allowing the movement of the lever member 51.

When the lever members 51 are at the position shown in FIG. 4A, the heat transfer plate 4 undergoes urging force of the springs 50 to contact with the bottom surface of the battery case 1. When subjected to the driving force from the motor 8 in the state shown in FIG. 4A, the lever member 51 moves in the direction of the arrow A2 against the urging force of the springs 50. The heat transfer plate 4 is pushed by the lever members 51 and is separated from the bottom surface of the battery case 1 as shown in FIG. 4B.

On the other hand, when the lever members 51 are moved in the direction of the arrow A1 by the driving of the motor 8 in the state shown in FIG. 4B, the heat transfer plate 4 undergoes the urging force of the springs 50 to move in the direction of the arrow A1 until the heat transfer plate 4 stops at the position where it contacts with the bottom surface of the battery case 1. The lever members 51 are pulled into the space close to the side of the battery case 1 as shown in FIG. 4A.

The position where the lever members 51 stop after the movement in the direction of the arrow A2 can be set as appropriate. Specifically, the lever members 51 may be stopped at any position after the heat transfer plate 4 is moved to the position separate from the bottom surface of the battery case 1.

In the modification, the control of the driving of the lever members 51 can be performed by a control circuit 6 (FIG. 2) similarly to Embodiment 1. The control operation is similar to that described in Embodiment 1 (see FIG. 3). The modification can provide the same effects as those in Embodiment 1.

While Embodiment 1 and the modification have the configurations in which the heat transfer plate 4 formed as the single member contacts with the overall bottom surface of the battery case 1, it is possible to employ a different configuration in which a plurality of heat transfer plates are provided and contact with different areas of the bottom surface of the battery case 1. The configuration can achieve partial heat radiation of the bottom surface of the battery case 1.

### Embodiment 2

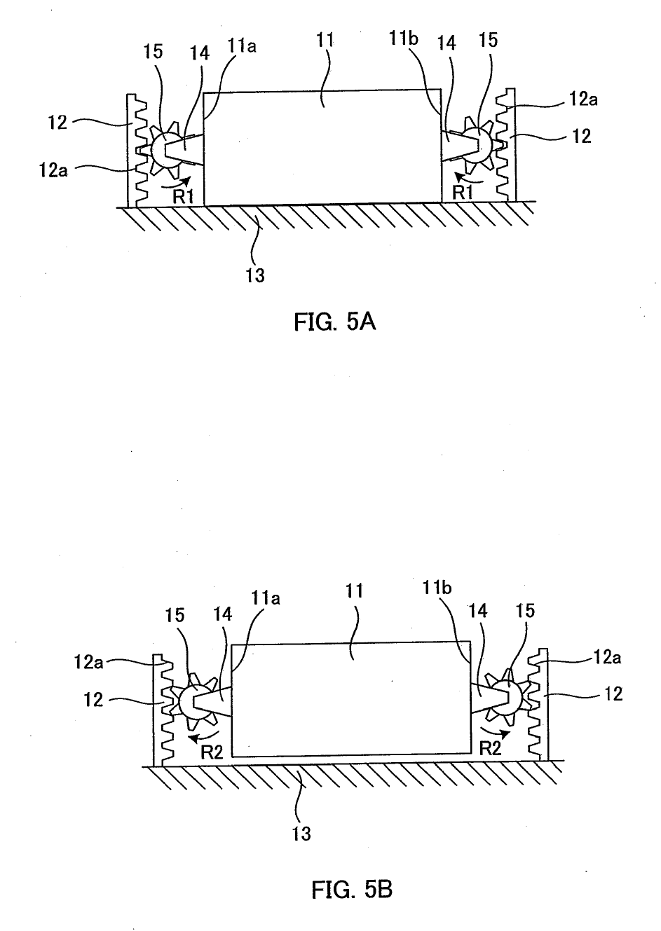

Next, the configuration of a cooling apparatus which is Embodiment 2 of the present invention will be described with reference to FIGS. 5A and 5B. The cooling apparatus of Embodiment 2 is mounted on a vehicle similarly to Embodiment 1.

In FIGS. 5A and 5B, a battery case 11 houses a battery unit (not shown) similarly to Embodiment 1. A fluid for cooling may be contained in the battery case 11 similarly to Embodiment 1.

Arm portions 14 are provided for sides 11a and 11b of the battery case 11 that are opposed to each other. Each of the arm portions 14 rotatably supports a gear 15 at an end of the arm portion 14. The gears 15 are coupled to the power transmission mechanism 9 as described in Embodiment 1 (FIG. 2) and are rotatable in response to driving force from a motor 8.

Supporting members 12 are provided for a vehicle body 13 and have gear portions 12a which mesh with the gears 15. The gear portion 12a extends in a direction in which the battery case 11 moves, later described.

As later described, heat of the battery case 11 is transferred to the vehicle body 13 when the battery case 11 contacts with the vehicle body 13.

In the abovementioned configuration of the cooling apparatus, when the gear 15 rotates in response to the driving force from the motor 8, the gear 15 moves along the gear portion 12a to move the battery case 11. Specifically, when the respective gear 15 is rotated in a direction of an arrow R1 in a state (first state) shown in FIG. 5A, the battery case 11 moves in a direction away from the vehicle body 13.

When the rotation of the gear 15 is stopped, the battery case 11 can be held in a state (second state) shown in FIG. 5B. In the state shown in FIG. 5B, the supporting members 12 hold the battery case 11 via the gears 15 and the arm portions 14.

On the other hand, when the motor 8 is driven to rotate the gear 15 in a direction of an arrow R2 in the state shown in FIG. 5B, the battery case 11 moves in a direction closer to the vehicle body 13. The rotation of the gear 15 is stopped at the time when the battery case 11 contacts with the vehicle body 13, thereby achieving the state shown in FIG. 5A.

Various control methods can be used to stop the battery case 11 at the position separate from the vehicle body 13 or to stop the battery case 11 at the position where it contacts with the vehicle body 13.

Specifically, a sensor adapted to detect the position of the battery case 11 may be provided, and the movement of the battery case 11 may be stopped on the basis of the output from the sensor. Alternatively, the driving amount of the motor 8 (for example, the number of pulses given by a pulse generator provided for the power transmission mechanism 9) may be counted, and the movement of the battery case 11 may be stopped at the time when the count reaches a predetermined value. On the other hand, the gear 15 may be moved to the end of the supporting member 12 (gear portion 12a), and an overload state via the gear 15 may be detected to stop the movement of the battery case 11.

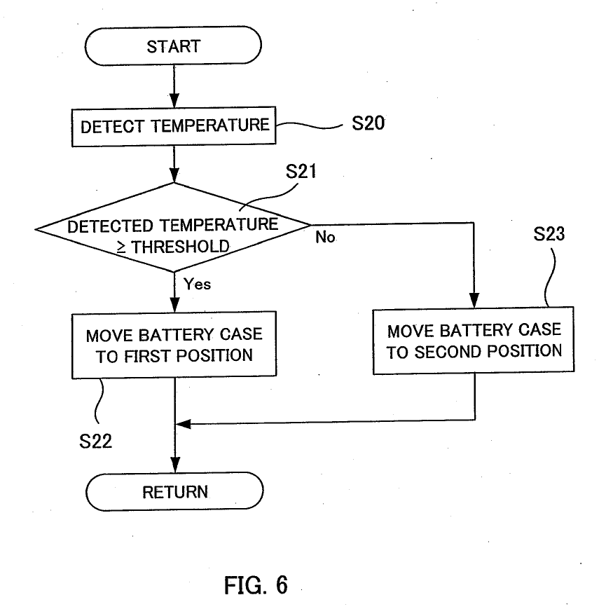

Next, the operation of a control circuit in Embodiment 2 will be described with reference to a flow chart in FIG. 6. The configuration for controlling the driving of the cooling apparatus of Embodiment 2 is similar to that in Embodiment 1 (FIG. 2) and the same members are designated with the same reference numerals.

At step S20, the control circuit 6 detects the temperature of the battery case 11 based on the output from a temperature sensor 7. At step S21, the control circuit 6 determines whether the temperature detected by the temperature sensor 7 is equal to or higher than a threshold. When the detected temperature is equal to or higher than the threshold, the flow proceeds to step S22. When the detected temperature is lower than the threshold, the flow proceeds to step S23.

The threshold refers to a temperature used as a criterion for preventing excessive cooling or an increase in temperature of the battery case 11 (battery unit placed within the battery case 11) and is set previously. Specifically, when the temperature of the battery case 11 is lower than the threshold, the battery case 11 (battery unit) may be cooled excessively, and when the temperature of the battery case 11 is equal to or higher than the threshold, the increased temperature of the battery case 11 (battery unit) causes problems in the operation of the battery unit. The specific value of the threshold can be set as appropriate in view of the abovementioned considerations.

At step S22, the control circuit 6 controls the driving of the motor 8 to rotate the gear 15 and then move the battery case 11 to a first position where it contacts with the vehicle body 13. The battery case 11 contacting with the vehicle body 13 in this manner allows the heat of the battery case 11 to be radiated to the vehicle body 13 to prevent an increase in temperature of the battery case 11.

At step S23, the control circuit 6 controls the driving of the motor 8 to rotate the gear 15 and then move the battery case 11 to a second position where it is separate from the vehicle body 13. The separation of the battery case 11 from the vehicle body 13 in this manner can prevent the battery case 11 from being cooled more than necessary through the vehicle body 13.

Specifically, when the vehicle body 13 is excessively cooled due to the ambient temperature and the battery case 11 contacts with the vehicle body 13, the battery case 11 may be cooled more than necessary through the vehicle body 13. The battery case 11 cooled excessively in this manner may lead to deterioration of the performance of the battery unit placed within the battery case 11.

To address this, in Embodiment 2, the battery case 11 is moved to the position separate from the vehicle body 13 as described above to prevent excessive cooling of the battery case 11 through the vehicle body 13.

While the gear 15 is rotated to move the battery case 11 in Embodiment 2, the present invention is not limited thereto. Specifically, similarly to the configuration described in Embodiment 1 (FIGS. 1A and 1B), the battery case 11 may be fixed to the vehicle body 13 via a fixing member, and a heat transfer plate (corresponding to the heat transfer plate 4 in Embodiment 1) which can contact with the battery case 11 can be moved by the driving mechanism (including the gears 15 and the supporting members 12) of Embodiment 2. In other words, the heat transfer plate can be provided with the gear and moved by the rotation of the gear.

Alternatively, the battery case 11 and the heat transfer plate (corresponding to the heat transfer plate 4 of Embodiment 1) may be moved by the driving mechanism of Embodiment 2. Specifically, in addition to the configuration shown in FIGS. 5A and 5B, an arm portion (corresponding to the arm portion 14) and a gear (corresponding to the gear 15) can be provided for the heat transfer plate, and the gear can mesh with the gear portion 12a of the supporting member 12.

In the configuration, one of the battery case 11 and the heat transfer plate can be moved or both of them may be moved. The battery case 11 and the heat transfer plate may be moved between the contacting state and the non-contacting state in the configuration as in the abovementioned case.

Such a configuration also enables the switching between the state in which the heat transfer plate contacts with the battery case 11 and the state in which the heat transfer plate is separate from the battery case 11. This can prevent an increase in temperature of the battery case 11 and excessive cooling of the battery case 11.

A heat transfer material (for example, heat transfer grease) may be applied to or a heat transfer sheet may be formed on at least one of the contacting surfaces of the battery case 11 and the vehicle body 13 to improve the heat conductivity in Embodiment 2.

### Embodiment 3

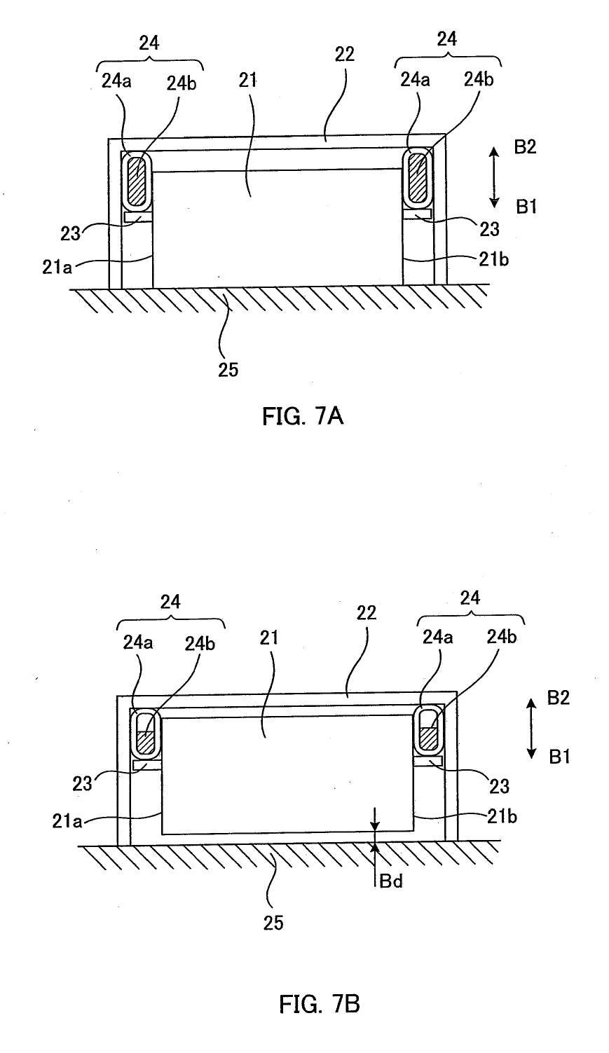

Next, the configuration of a cooling apparatus which is Embodiment 3 of the present invention will be described with reference to FIGS. 7A and 7B.

In FIGS. 7A and 7B, a battery case 21 houses a battery unit (not shown) similarly to Embodiment 1. A fluid for cooling may be contained in the battery case 21 similarly to Embodiment 1. Arm portions 23 are provided for sides 21a and 21b of the battery case 21 that are opposed to each other such that the arm portions 23 protrude from the sides 21a and 21b. A portion of each of expandable/contractible members 24, later described, is fixed to each of the arm portions 23.

An outer case 22 surrounding the battery case 21 is fixed to a vehicle body 25. A portion of each of the expandable/contractible members 24 is fixed to an inner surface (upper surface) of the outer case 22. Thus, the battery case 21 is supported by the outer case 22 via the arm portions 23 and the expandable/contractible members 24.

As later described, heat of the battery case 21 is transferred to the vehicle body 25 when the battery case 21 contacts with the vehicle body 25.

While the outer case 22 is provided for supporting the battery case 21 in Embodiment 3, the battery case 21 may be supported by part of the vehicle on which the cooling apparatus of Embodiment 3 is mounted, instead of the outer case 22.

Each of the expandable/contractible members 24 is formed by containing a low-boiling-point solvent 24b in an elastic body 24a. For the low-boiling-point solvent 24b, it is possible to use cycloalkane (more specifically, cyclobutane having a boiling point of 13° C.), dichloromethane, hydrochlorofluorocarbon, hydrofluorocarbon, acetone, hexane, and isopentane, for example. The low-boiling-point solvent 24b is not limited to the abovementioned materials, and it is possible to use any material that has a boiling point equal to a predetermined temperature (temperature corresponding to the thresholds described in Embodiments 1 and 2). The elastic body 24a may be made of any material that can expand and contract, and for example, a polymer resin such as an elastomer can be used.

While the expandable/contractible member 24 including the elastic body 24a and the low-boiling-point solvent 24b is used in Embodiment 3, the present invention is not limited thereto, and it is possible to use any member that changes in shape when the temperature changes. Specifically, bimetal (a plurality of bonded metals having different coefficients of thermal expansion) or a shape-memory alloy can be used.

In the abovementioned configuration of the cooling apparatus, when the ambient temperature (temperature outside the battery case 21) is equal to or higher than the predetermined value (equal to or higher than the boiling point of the low-boiling-point solvent 24b), the low-boiling-point solvent 24b of the expandable/contractible member 24 is vaporized to expand the elastic body 24a. Under the expansion effect of the expandable/contractible member 24, the arm portion 23 is moved in a direction of an arrow 21 in FIGS. 7A and 7B (in other words, a direction in which it approaches the surface of the vehicle body 25).

This also moves the battery case 21 in the direction of the arrow 21 and the bottom surface of the battery case 21 contacts with the vehicle body 25 (see FIG. 7A). The battery case 21 remains contacting with the vehicle body 25.

On the other hand, when the ambient temperature becomes lower than the predetermined value (boiling point of the low-boiling-point solvent 24b) in the state shown in FIG. 7A, the vaporized low-boiling-point solvent 24b is changed into a fluid. The elastic body 24a, which has been expanded by the vaporized low-boiling-point solvent 24b, contracts to move the arm 23 in a direction of an arrow B2 (in other words, a direction in which it is separated away from the surface of the vehicle body 25).

This also moves the battery case 21 in the direction of the arrow B2 to separate the bottom surface of the battery case 21 from the vehicle body 25.

A spacing Bd between the bottom surface of the battery case 21 and the surface of the vehicle body 25 in the state shown in FIG. 7B is determined on the basis of the lengths of the expandable/contractible member 24 while it expands and contracts (length in the direction of the arrow B1 or the direction of the arrow B2). Specifically, the spacing Bd is set such that the relationship Bd is satisfied where B1 represents a change amount (length) of the expandable/contractible member 24 when it expands and contracts. Thus, when the expandable/contractible member 24 expands, the bottom surface of the battery case 21 can contact with the vehicle body 25 reliably.

According to the cooling apparatus of Embodiment 3, when the ambient temperature is equal to or higher than the predetermined value (value corresponding to the thresholds described in Embodiments 1 and 2), the expandable/contractible member 24 expands to contact the battery case 21 with the vehicle body 25. Therefore it is possible to achieve efficient heat radiation of the battery case 21. Even when the battery unit placed within the battery case 21 generates heat due to charge and discharge, the heat of the battery case 21 can easily escape to the vehicle body 25 to prevent an increase in temperature of the battery case 21 (battery unit).

On the other hand, when the ambient temperature is lower than the predetermined value, the expandable/contractible member 24 contracts to separate the battery case 21 from the vehicle body 25. Therefore it is possible to prevent excessive cooling of the battery case 21. Specifically, when the vehicle body 25 is excessively cooled due to the ambient temperature, the battery case 21 which remains contacting with the vehicle body 25 may be excessively cooled through the vehicle body 25 to deteriorate the performance of the battery unit placed within the battery case 21. Thus, as described above, the battery case 21 can be separated from the vehicle body 25 to prevent the vehicle body 25 from excessively cooling the battery case 21.

Since the expandable/contractible member 24 which changes in shape depending on the ambient temperature is used in Embodiment 3, a control mechanism for moving the battery case 21 can be omitted. This can reduce the size and cost of the vehicle including the cooling apparatus of Embodiment 3.

In Embodiment 3, a sensor adapted to detect the position of the battery case 21 may be provided. When the detection sensor is provided, it is possible to monitor reliably the contact of the battery case 21 with the vehicle body 25 or the separation of the battery case 21 from the vehicle body 25. Specifically, the outer case 22 can be provided with a sensor adapted to detect the arm portions 23 reaching the position shown in FIG. 7A and a sensor adapted to detect the arms 23 reaching the position shown in FIG. 7B.

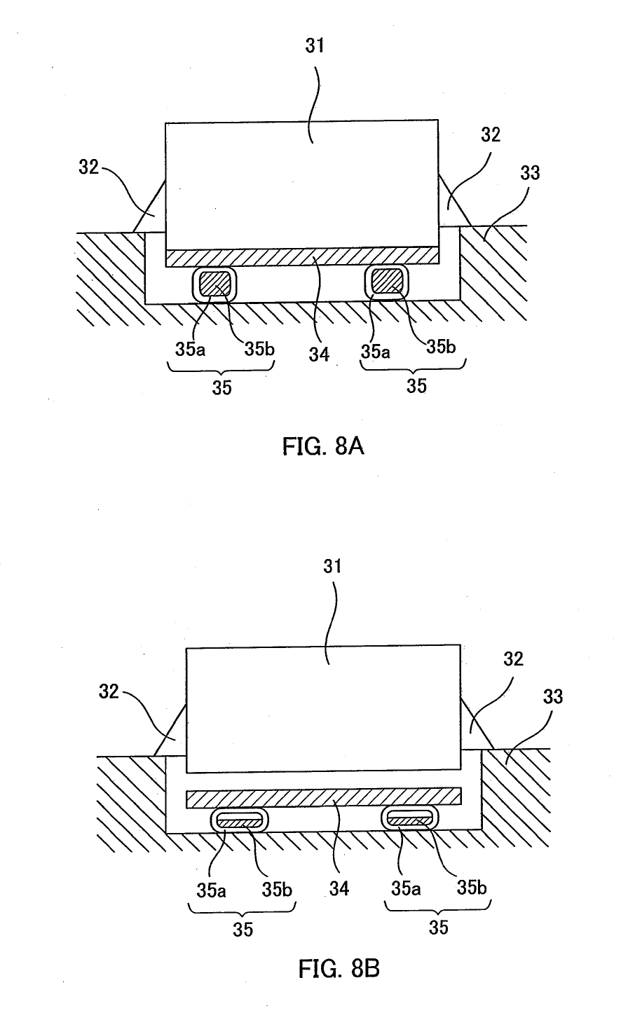

Next, a cooling apparatus which is a modification of Embodiment 3 will be described with reference to FIGS. 8A and 8B. Embodiment 3 has been described in conjunction with the configuration in which the battery case 21 is moved by the expansion and contraction of the expandable/contractible member 24. In the modification, a heat transfer plate is moved by expansion and contraction of an expandable/contractible member.

In FIGS. 8A and 8B, a battery case 31 houses a battery unit (not shown) similarly to Embodiment 1. A fluid for cooling may be contained in the battery case 31 similarly to Embodiment 1. The battery case 31 is fixed to a vehicle body 33 via fixing members 32. In other words, the battery case 31 is placed at a position separate from the surface of the vehicle body 33 by the fixing members 32.

Expandable/contractible members 35 are placed in the space between the battery case 31 and the vehicle body 33. Each of the expandable/contractible members 35 is partially fixed to the surface of the vehicle body 33 and to a heat transfer plate 34. Similarly to Embodiment 3, the expandable/contractible member 35 is formed of an elastic body 35a and a low-boiling-point solvent 35b contained in the elastic body 35a. The number of the expandable/contractible members 35 can be set as appropriate. For example, the expandable/contractible member 35 can be placed near each of four corners of the heat transfer plate 34.

When the ambient temperature is equal to or higher than a predetermined value (equal to or higher than the boiling point of the low-boiling-point solvent 35b), the expandable/contractible member 35 (elastic body 35a) expands to contact the heat transfer plate 34 with the bottom surface of the battery case 31. On the other hand, when the ambient temperature is lower than the predetermined value, the expandable/contractible member 35 (elastic body 35a) contracts to separate the heat transfer plate 34 from the bottom surface of the battery case 31.

In the modification, bimetal or a shape memory alloy may be used as the expandable/contractible member instead of the elastic body 35a containing the low-boiling-point solvent 35b.

The modification can achieve the same effects as those in Embodiment 3 described above. In addition, since the heat transfer plate 34 lighter than the battery case 31 is moved in the modification, the expandable/contractible member 35 can be reduced in size.

In the modification, a sensor adapted to detect the position of the heat transfer plate 34 may be provided. When the detection sensor is provided, it is possible to monitor reliably the contact of the heat transfer plate 34 with the battery case 21 or the separation of the heat transfer plate 34 from the battery case 21. Specifically, the vehicle body 33 can be provided with a sensor adapted to detect the heat transfer plate 34 reaching the position shown in FIG. 8A and a sensor adapted to detect the heat transfer plate 34 reaching the position shown in FIG. 8B.

A heat transfer material (for example, heat transfer grease) may be applied to or a heat transfer sheet may be formed on at least one of the contacting surfaces of the battery case 21 and the vehicle body 25 (or the battery case 31 and the heat transfer plate 34) to improve the heat conductivity in Embodiment 3 and the modification.

### Embodiment 4

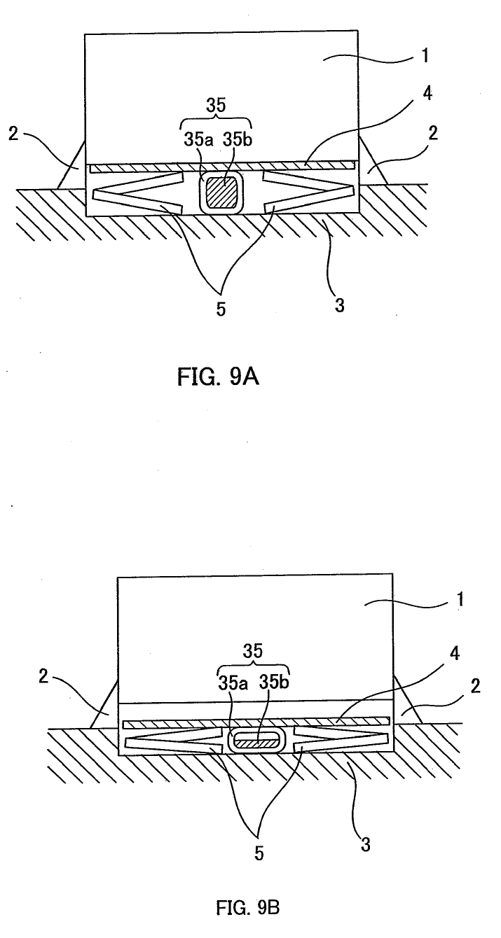

Next, the configuration of a cooling apparatus which is Embodiment 4 of the present invention will be described with reference to FIGS. 9A and 9B.

The cooling apparatus of Embodiment 4 employs both of the configuration of the cooling apparatus described in Embodiment 1 (see FIGS. 1A and 1B) and the expandable/contractible member described in Embodiment 3 (see FIGS. 8A and 8B). The cooling apparatus of Embodiment 4 will hereinafter be described in detail. In FIGS. 9A and 9B, members identical to those described in Embodiment 1 (FIGS. 1A and 1B) and Embodiment 3 (FIGS. 8A and 8B) are designated with the same reference numerals.

In FIGS. 9A and 9B, each of elevators 5 has one end fixed to a vehicle body 3 and another end fixed to a heat transfer plate 4 similarly to Embodiment 1 (FIGS. 1A and 1B).

An expandable/contractible member 35 has a portion fixed to the vehicle body 35 and another portion fixed to the heat transfer plate 4. Specifically, the expandable/contractible member 35 is secured to the vehicle body 3 and the heat transfer plate 4 by an adhesive or the like.

The expandable/contractible member 35 is formed of an elastic body 35a and a low-boiling-point solvent 35b contained in the elastic body 35a similarly to Embodiment 3 (FIGS. 8A and 8B). The elastic body 35a and the low-boiling-point solvent 35b can be made of the materials described in Embodiment 3.

In Embodiment 4, when the ambient temperature is equal to or higher than a predetermined value (equal to or higher than the boiling point of the low-boiling-point solvent 35b), the low-boiling-point solvent 35b is vaporized to expand the expandable/contractible member 35 (elastic body 35a), and the expansion stretches the elevators 5 (see FIG. 9A). This causes the heat transfer plate 4 to contact with the bottom surface of the battery case 1. In this state, heat of the battery case 1 is transferred to the heat transfer plate 4 to provide efficient heat radiation to the outside of the battery case 1.

On the other hand, when the ambient temperature is lower than the predetermined value, the low-boiling-point solvent 35b is liquefied to contract the expandable/contractible member 35 (elastic body 35a), and the contraction shrinks the elevators 5 (see FIG. 9B). This causes the heat transfer plate 4 to separate from the bottom surface of the battery case 1. In this state, since the battery case 1 is separate from the surface of the vehicle body 3 by the fixing members 2, it is possible to prevent the cooled vehicle body 3 from cooling the battery case 1.

Embodiment 4 can provide the same effect as those in Embodiments described above. Specifically, it is possible to prevent an increase in temperature of the battery case 1 and to prevent excessive cooling of the battery case 1. In addition, since the heat transfer plate 4 is moved by the expansion and contraction of the expandable/contractible member 35 depending on the change in the ambient temperature, a control mechanism for moving the heat transfer plate 4 can be omitted.

Since the elevators 5 are also used in Embodiment 4, the number of the expandable/contractible member 35 can be reduced as compared with the configuration described in Embodiment 3 (FIGS. 8A and 8B). For example, as shown in FIGS. 9A and 9B, the only one expandable/contractible member 35 may be placed between the two elevators 5.

In Embodiment 4, a sensor adapted to detect the position of the heat transfer plate 4 may be provided similarly to Embodiment 3. When the detection sensor is provided, it is possible to monitor reliably the contact of the heat transfer plate 4 with the battery case 1 or the separation of the heat transfer plate 4 from the battery case 1. Specifically, the vehicle body 3 can be provided with at least a sensor adapted to detect the heat transfer plate 4 reaching the position shown in FIG. 9A.

A heat transfer material (for example, heat transfer grease) may be applied to or a heat transfer sheet may be formed on at least one of the contacting surfaces of the battery case 1 and the heat transfer plate 4 to improve the heat conductivity in Embodiment 4.

While Embodiment 4 has been described in the case where the one expandable/contractible member 35 is used, the number of the expandable/contractible member 35 can be set as appropriate. Bimetal or a shape memory alloy can be used as another expandable/contractible member instead of or in addition to the expandable/contractible member 35.

The configuration of the cooling apparatus of the present invention is not limited to the configurations described in Embodiments 1 to 4. Specifically, any configuration can be used as long as at least one of the battery case and the heat transfer plate is moved to perform the switching between the contacting state and the non-contacting state.

While the bottom surface of the battery case contacts with the heat transfer plate or the vehicle body in Embodiments 1 to 4 described above, the present invention is not limited thereto. It is essential only that the contact of the battery case can result in radiation of heat of the battery case, so that the heat transfer plate or the vehicle body may contact with a surface of the battery case other than the bottom surface. Specifically, the configuration described below can be used.

First, a heat insulating member is provided between the bottom surface of the battery case and the vehicle body, and the battery case is fixed to the vehicle body via the heat insulating member. The placement of the heat insulating member between the battery case and the vehicle body can prevent the excessively cooled vehicle body from cooling the battery case more than necessary.

Then, a driving mechanism is provided which is adapted to move a heat transfer plate relative to a side of the battery case. The heat transfer plate has a surface opposite to the side of the battery case. In this configuration, when the heat transfer plate contacts with the side of the battery case, heat of the battery case can escape to the outside to prevent an increase in temperature of the battery case (battery unit). When the heat transfer plate is separated from the side of the battery case, it is possible to prevent the excessively cooled vehicle body from cooling the battery case more than necessary.

1. A cooling apparatus which is mounted on a vehicle, comprising:
a case which houses a power storage unit;
and
a driving mechanism which moves the case relative to a vehicle body and operates between a first state in which the case and the vehicle body are in a contacting state and a second state in which the case and the vehicle body are in a non-contacting state.

2. (canceled)

3. The cooling apparatus according to claim 1, wherein the driving mechanism has:
a gear which is provided for the case; and
a supporting member which meshes with the gear and supports the case via the gear,
wherein the driving mechanism moves the case between the contacting state and the non-contacting state by changing a meshing position of the gear with the supporting member.

4. The cooling apparatus according to claim 1, further comprising:
a detection sensor which is adapted to detect a temperature of the power storage unit; and
control device which controls driving of the driving mechanism,
wherein the control device drives the driving mechanism between the first state and the second state based on the temperature detected by the detection sensor.

5. The cooling apparatus according to claim 4, wherein the control device drives the driving mechanism into the first state when the temperature detected by the detection sensor is equal to or higher than a threshold and the control device drives the driving mechanism into the second state when the detected temperature is lower than the threshold.

6. The cooling apparatus according to claim 1, wherein the driving mechanism has an expandable/contractible member which can expand and contract depending on a temperature outside the case.

7. The cooling apparatus according to claim 6, wherein the expandable/contractible member has an elastic body capable of elastic deformation and a low-boiling-point solvent contained in the elastic body.

8. (canceled)

9. The cooling apparatus according to claim 1, further comprising a heat transfer material provided for at least one of surfaces of the case and of the vehicle body, the surfaces contacting each other.

10. The cooling apparatus according to claim 1, wherein the case contains a fluid for use in cooling the power storage unit.

11. A vehicle comprising the cooling apparatus according to claim 1.

12. (canceled)

13. (canceled)
